(19) United States
(12) Patent Application Publication
(10) Pub. No.: US 2004/0103306 A1
(43) Pub. Date: May 27, 2004

(54) System and method for administering permisson for use of information

(76) Inventors: Raymond Eugene Paddock, Louisville, CO (US); Mark Clinton Knox, Lafayette, CO (US)

Correspondence Address: LAW OFFICE OF DONALD D. MONDUL, 6631 LOVINGTON DRIVE, DALLAS, TX, 75252, US

(21) Appl. No.: 10/712,605

(22) Filed: Nov. 12, 2003

Related U.S. Application Data
(60) Provisional application No. 60/428,041, filed on Nov. 21, 2002.

(51) Int. Cl. H04L 9/32

(52) U.S. Cl. 713/200

(57) ABSTRACT

A system for administering permission for use of specified information owned by an information owner in a use circumstance by an information user includes: (a) an information control unit for comparing an information use permission request with information use directions for effecting the administering; the information use permission request identifying at least the information and the use circumstance; the information use directions including criteria prescribing permitted use of the information; (b) a communication facility coupled with the information control unit for effecting communication to receive the information use permission request from the information user; the information control unit communicating a permitting indicator to the information user when the use circumstance conforms with the information use directions for the information; and (c) an information storage unit coupled with at least one of the information control unit and the communication facility for storing the information use directions.

This application claims benefit of prior filed copending Provisional Patent Application Serial No. 60/428,041, filed Nov. 21, 2002.

### BACKGROUND OF THE INVENTION

The present invention is directed to a system and method for administering permission for use of information in respective use circumstances, and especially to administering permissions for use of personal information in respective use circumstances.

An impetus for the present invention is the premise that an individual owns any personal information pertaining to the individual, and the individual should control use of his personal information. Said another way, an individual should have control of uses for which his personal information is employed; his permission should be required before his personal information is used.

There are no systems or methods presently available for implementing the desired permission control, or administration, necessary to enforce the premise that an individual's personal information is owned by the individual. Some disclosures have been made regarding structural aspects relating to database arrangements for identifying information personal to an individual, and recording certain preferences of an individual regarding uses of his personal information. For example, U.S. Pat. No. 6,253,203 to O'Flaherty et al. for “Privacy-Enhanced Database” of Jun. 26, 2001, discloses a memory structure that includes a database table having a plurality of data control columns reflecting consumer privacy parameters.

U.S. patent application Publication Ser. No. 2001/0,011,247 of Aug. 2, 2001, by O'Flaherty et al. discloses a method and system for providing a customer unique proxy manifested in a privacy card issued to the consumer. The consumer uses the privacy card for imposing privacy preferences upon data in the database. In one use of the privacy card, the consumer may access a privacy service that enables the consumer to remove all information from which identity of the consumer may be determined.

U.S. Pat. No. 6,275,824 to O'Flaherty et al. for “System and Method for Managing Privacy in a Database Management System” of Aug. 14, 2001, discloses a database management system for storing and retrieving data from a plurality of database tables wherein the data in the database tables is controllably accessible according to privacy parameters stored in the database table.

U.S. Pat. No. 6,438,544 to Grimmer et al. for “Method and Apparatus for Dynamic Discovery of Data Model Allowing Customization of Consumer Applications Accessing Privacy Data” of Aug. 20, 2002, a system and apparatus including use of a privacy metadata subsystem coupled with a data warehouse and a consumer access subsystem coupled to the data warehouse and to the privacy metadata subsystem. The consumer access subsystem accepts a request for privacy information from a client and translates the request to a data warehouse-compliant query, transmits the query to the data warehouse and forwards data responsive to the query to the client.

The representative disclosures cited address site-specific solutions to provide identification of privacy or personal information and provide for its special handling in a respective database at a respective location. For purposes of this application, the terms “privacy information”, “private information” and “personal information” are substantially synonymous.

There is a need, however, for a broader handling capability of privacy information. In today's society there are many holders of information relating to individuals. Examples of entities holding information relating to individuals include credit card issuing companies, loyalty card companies, on-line retail companies, product warranty information companies, magazine subscription processing companies and others. As mentioned earlier herein, a basic premise is that privacy information relating to a party belongs to that party, not to whoever may hold the privacy information. There is a need for a system or service or method for recording information owners' preferences regarding handling of their personal or private information in a manner that permits enforcing those preferences upon uses of such information.

There is a need for a system and method for administering permission by an information owner for use of specified information in a respective use circumstance by an information user.

### SUMMARY OF THE INVENTION

A system for administering permission for use of specified information owned by an information owner in a use circumstance by an information user includes: (a) an information control unit for comparing an information use permission request with information use directions for effecting the administering; the information use permission request identifying at least the information and the use circumstance; the information use directions including criteria prescribing permitted use of the information; (b) a communication facility coupled with the information control unit for effecting communication to receive the information use permission request from the information user; the information control unit communicating a permitting indicator to the information user when the use circumstance conforms with the information use directions for the information; and (c) an information storage unit coupled with at least one of the information control unit and the communication facility for storing the information use directions.

A method for administering permission for use of information owned by an information owner in a use circumstance by an information user includes the steps of: (a) establishing predetermined information use directions including use criteria prescribing permitted use of the information and identifying criteria specifying the information owner; (b) receiving an information use permission query from the information user; the information use permission query identifying at least the information and the use circumstance; (c) comparing the information use permission query with the information use directions; (d) providing a permitting indicator to the information user when the use circumstance conforms with the information use directions for the information.

It is, therefore, an object of the present invention to provide a system and method for administering permission by an information owner for use of specified information in a respective use circumstance by an information user.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram of a system for administering permission for use of information according to the present invention.

FIG. 2 is a flow diagram illustrating the method of the present invention.

### DETAILED DESCRIPTION OF THE PREFERRED EMBODIMENT

The system and method of the present invention are preferably embodied in a service offering provided to an entity that wishes to use information held by that entity about an individual (information owner), when the entity does not have permission to use the information. The service is performed on behalf of the information owner. Courts and regulatory bodies may render decisions as to who “owns” certain properties in the future. The present invention is intended to accommodate such decisions and operate to administer permissions for information belonging to such deemed information owners, who may include a person or an organization, as well as other individual information owners. In practice, it is anticipated that the service will be performed for a group of information owners, each with his own respective permissions (information use directions) recorded and stored in an information storage unit for administering by the service provider.

By way of example and not by way of limitation, personal information protected by permissions in the system includes information pertaining to family, financial data, lifestyle preferences and practices and personal interests. Preferably, information is stored in a storage unit in various information elements (e.g., name, address, social security number, and various individual permission parameters or limitations) in a recoverable form identifying each respective information element with a respective information owner.

The contemplated service embodies the system and method of the present invention to permit information users to obtain permission from information owners to use their personal information according to the limits on use imposed by the information owners. Information owners are contemplated by the present invention as being enabled to set forth predetermined use parameters identifying generic use limitations. Information owners may, for example, set forth limitations or use parameters on use of their information as to who can use it, how it may be used, when it may be used, what information can be used, and additional limitations. Preferably, any limitation or use parameter may be imposed on an individual information element, on groups of information elements, or on all information elements associated with a respective information owner.

When an information user seeks to obtain permission to use information for a respective use circumstance, a permitting indicator or permission response (i.e., either granting or denying permission) may be delivered to the information user in real time or in a batch mode. Whether to grant or deny permission for use is determined by the service embodying the system and method of the present invention by comparing the information use permission request submitted by the information user with the information use directions embodied in the information owner's stored use parameters.

The exemplary embodiments of the method and system of the present invention described herein are simple and straightforward to facilitate understanding the invention. As numbers of subscribers or numbers of information owners increase, it would become unwieldy to operate the service embodying the system and method of the invention using a single service point or even a few service points. Thus, the system of the present invention includes an embodiment in which logic and data are distributed among selected information users. In such an alternate system, a bundle of logic and data may be installed at an information user's location in the information user's computer equipment. The bundle of logic and data may be “called” by the information user to receive permission to use the specified information in the particular use circumstance. The bundle of logic and data would be updated at intervals or continuously to ensure proper administering of permissions.

The types of information that can be administered are varied as well. By way of example, and not by way of limitation, the system and method of the invention may be used to administer permissions by a musician or songwriter vis-à-vis downloading musical works over the Internet or to administer permissions by an author vis-à-vis reprinting the author's novel. The scope of the terms “owner” and “information” are intentionally broad in the context of the invention disclosed herein.

It is contemplated that communication among the various participants in operation of the service—the information control unit of the system of the invention and the information users—may be by one or more of various communication milieux including, by way of example and not by way of limitation, Internet web site inputting of information; e-mail via the Internet or another network; telephone communication via a public switched telephone network, a wireless telephone network, voice over Internet protocol (VoIP) or another telephone system or network; facsimile communications; or another communication milieu. Similar communication milieux may also be employed for conveying information use directions from a newly subscribing information owner or for conveying updated information use directions or changes from an already subscribed information owner. It is contemplated that information owners may request right of review of any information use permission request query with a further right to permit or refuse each such request, and various communications may be employed in providing this aspect of the service. Further, it is contemplated that an information owner may update their respective information use directions using an example of information they decide should not be allowed or a using as an example a citation of an instance when information was permitted for use that they believe should not have been allowed. Such information owner communications and updating may be carried out in real time or in a batch mode.

Additionally, the service embodying the system and method of the invention may broadcast notification to information users that new subscribers have subscribed to the service, or that changes have been recorded in the information use directions of certain information owners. Recipients of such broadcasts may be selected, for example, from among subscribing information users or from identifiable industry groups such as banks, insurance companies, telephone companies, or other industry groups.

Externally generated limitations for information use may also be facilitated by the present invention. For example, some states require telemarketing companies to keep lists of individuals who have opted to be placed on a no-call list. Such no-call lists may be incorporated into the information stored by the present system so that the no-call status of an individual may be reflected in any response provided by the service to an information use permission request query submitted by an information user.

An information use permission request query may be posed by an information user in a form that describes desired information in general terms without specifying any owner requirements, so that a class of information may fit the description. The present invention contemplates that the service embodying the system and method of the invention may respond to such a descriptive request by providing identifying information from its permissions database—subject to the permissions limitations of the various subscribing information owners—to facilitate creation of a mailing list for an inquiring information user that is responsive to the descriptive request.

Another embodiment of the present invention contemplates providing communication between the information control unit of the system and a plurality of remote databases. Such remote databases may be maintained by entities other than the provider of the service embodying the system and method of the present invention. Managers of such remote data bases may subscribe to the service embodying the system and method of the present invention to participate in the service. In a system involving such an expanded subscriber database configuration, an information user may submit an information use permission request query and the service will peruse subscribing databases as well as its own permissions database in formulating a permitting indicator response to the requesting information user. The perusing may be carried out using communication in any of various communication milieux, as discussed above in connection with communication with information users and information owners.

The preferred embodiment of the invention provides appropriate coding to communications and transactions among information users, information owners, remote database managers and the information control unit of the system of the invention so that audit trails may be established for reviewing operations of the system and service.

It is further contemplated that information owners, information users and remote database managers each may participate in the service embodying the system and method of the invention through agents or other intermediaries.

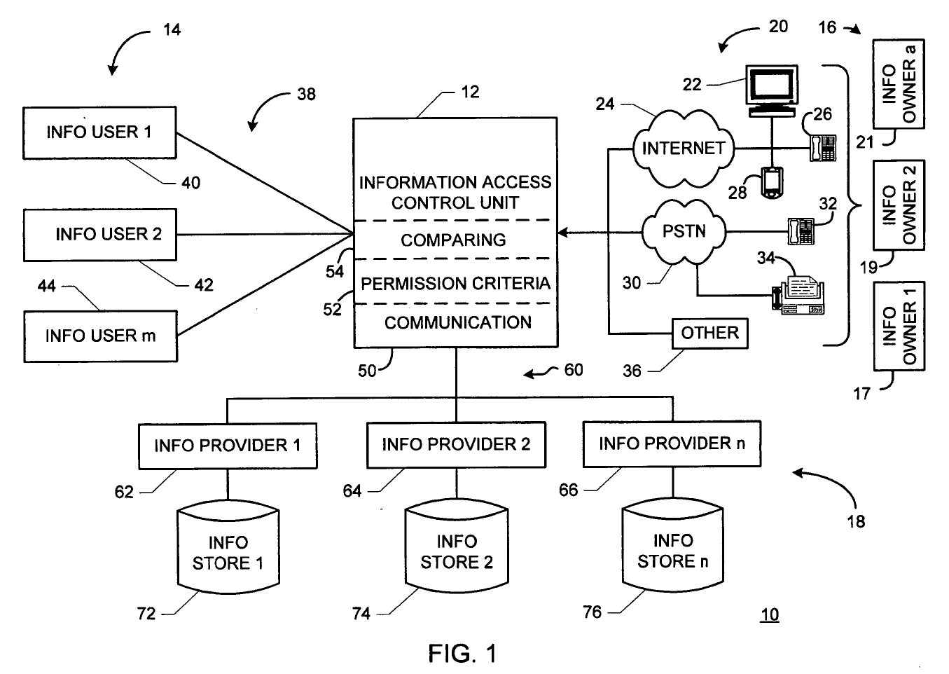

FIG. 1 is a schematic diagram of a system for administering permission for use of information according to the present invention. In FIG. 1, a system 10 for administering permission for use of specified information in a respective circumstance by at least one information user includes an information access control unit 12 communicatingly coupled with a plurality of information users 14 and at least one information-owner 16 including information owners 17, 19, 21. An information owner 17, 19, 21 communicates with information access control unit 12 via any one or more of a plurality of communication milieux 20. Communication milieux 20 may include, for example, website access 22 via the Internet 24, voice over Internet protocol (VoIP) 26 via the Internet 24, other devices 28 (e.g., wireless personal digital assistant (PDA) devices) via the Internet 24. Communication milieux 20 may also include phone communications via a public switched telephone network (PSTN) 30 such as voice phone communications 32 or facsimile communications 34. Other communications 36 may also be included within communication milieux 20, such as wireless communications or another communication milieu. Information owner 21 is designated INFO OWNER “a” in FIG. 1; the indicator “a” is intended to indicate that there is no theoretical limit to the number of information owners 17, 19, 21 that can communicate with information access control unit 12 via communication milieux 20.

Information access control unit 12 is also communicatingly coupled with information users 14 via a plurality of communication milieux 38 (not illustrated in detail in FIG. 1). Communication milieux 38 may include similar communication connections as those described above in connection with communication milieux 20. Thus, an information user 40, 42, 44 may communicate with information access control unit 12 via one or more communication milieux 38. Information user 44 is designated INFO USER “m” in FIG. 1; the indicator “m” is intended to indicate that there is no theoretical limit to the number of information users 40, 42, 44 that can communicate with information access control unit 12 via communication milieux 38.

Information access control unit 12 includes a communication unit 50, a permission criteria storage unit 52 and a comparing unit 54. Thus, information owners 16 may, for example, set forth limitations or use parameters on use of their information as to who can use it, how it may be used, when it may be used, what information can be used, and additional limitations. These use parameters, or permission criteria, are conveyed to information access control unit 12 in information use directions via one or more of communication milieux 20 and communication unit 50. Information access control unit 12 stores the permission criteria in permission criteria storage unit 52. Preferably, any use parameter, or permission criterion may be imposed on an individual information element, on groups of information elements, or on all information elements associated with a respective information owner 17, 19, 21 in permission criteria storage unit 52.

When an information user 14 seeks to obtain permission to use information for a respective use circumstance, a respective information user 40, 42, 44 sends an information use permission request to information access control unit 12 via one or more of communication milieux 38. A permitting indicator or permission response (i.e., either granting or denying permission) may be delivered to the respective requesting information user 40, 42, 44 from information access control unit 12 via one or more of communication milieux 38 in real time or in a batch mode. Whether to grant or deny permission for use is determined by information access control unit 12 comparing the information use permission request submitted by the respective requesting information user 40, 42, 44 with permission criteria information received in information use directions from an information owner 16.

Additionally, information access control unit 12 may broadcast notification to information users 14 via one or more of communication milieux 38 that new subscribers (e.g., information owners 16) have subscribed to the service and recorded information use directions conveying permission criteria for storage in permission criteria storage unit 52, or that changes have been recorded in the permission criteria of certain information owners 16. Information users 14 receiving such broadcasts may be selected, for example, from among subscribing information users (e.g., information users 40, 42, 44; FIG. 1) or from identifiable industry groups such as banks, insurance companies, telephone companies, or other industry groups.

An information use permission request query may be posed by an information user 14 in a form that describes desired information in general terms without specifying any owner requirements, so that a class of information may fit the description. System 10 contemplates responding to such a descriptive request by providing identifying information from permissions criteria storage unit 52—subject to the permissions limitations of the various subscribing information owners 16 stored in permission criteria storage unit 52—to facilitate creation of a mailing list for an inquiring information user 14 that is responsive to the descriptive information use permission request.

Information access control unit 12 may also be communicatingly coupled with a plurality information providers 18 via a plurality of communication milieux 60 (not illustrated in detail in FIG. 1). Communication milieux 60 may include similar communication connections as those described above in connection with communication milieux 20, 38. Thus, an information provider 62, 64, 66 may communicate with information access control unit 12 via one or more communication milieux 60. Information provider 66 is designated INFO PROVIDER “n” in FIG. 1; the indicator “n” is intended to indicate that there is no theoretical limit to the number of information providers 62, 64, 66 that can communicate with information access control unit 12 via communication milieux 60.

Each respective information provider 60, 62, 66 has one or more associated information store, or database. Thus, information provider 62 has an associated information store 72, information provider 64 has an associated information store 74 and information store 66 has an associated information store 76. In an embodiment of system 10 that includes communication milieux 60 and information providers 18, information providers 18 may subscribe to participate in the service offered by information access control unit 12. An example of such a system embodiment involves information providers 18 who are database managers for remote databases embodied in information stores 72, 74, 76.

When system 10 employs such an expanded subscriber database configuration to include remote databases embodied in information stores 72, 74, 76, an information user 14 may submit an information use permission request query to information access control unit 12, and information access control unit 12 will peruse subscribing databases (information stores 72, 74, 76) as well as its own permissions database (permission criteria storage unit 52) in formulating a permitting indicator response to the requesting information user 14. The perusing by information access control unit 12 may be carried out using communication in any of various communication milieux in communication milieux 20, 38, 60, as discussed above in connection with communication among information owners 16, information access control unit 12, information users 14 and information providers 18.

The preferred embodiment of system 10 provides appropriate coding to communications and transactions among information users 14, information owners 16, information providers 18 and information access control unit 12 so that audit trails may be established for reviewing operations of system 10.

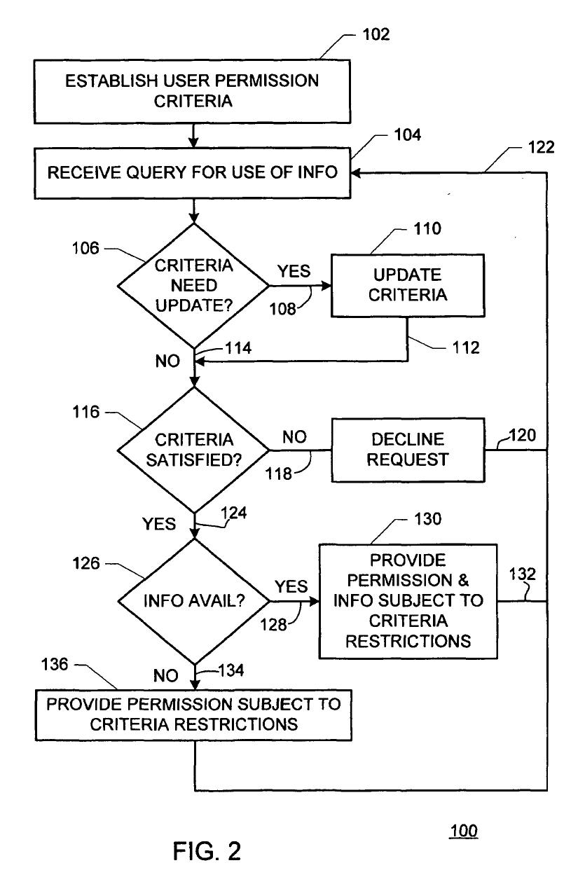

FIG. 2 is a flow diagram illustrating the method of the present invention. In FIG. 2, a method 100 for administering permission for use of specified information in a respective use circumstance by at least one information user begins with establishing user permission criteria, as indicated by a block 102. The user permission criteria are established in predetermined information use directions that include use criteria prescribing permitted use of the specified information. The specified information is owned by at least one information owner and the information use directions include identifying criteria that identify which respective information owner or owners own the specified information. The information use directions are preferably received by an information access control unit (e.g. information access control unit 12; FIG. 1).

Method 100 continues with the step of receiving an information use permission query from at least one information user, as indicated by a block 104. The information use permission query identifies at least the specified information and the respective use circumstance. A query is next posed to ascertain whether stored permission criteria obtained pursuant to the step represented by a block 102 need to be updated, as indicated by a query block 106. If the permission criteria need updating, method 100 proceeds according to YES response line 108 and the criteria are updated, as indicated by a block 110. Method 100 thereafter proceeds as indicated by line 112 to continue.

Such an updating query (as represented by query block 106) is not necessarily posed with each reception of an information use permission query. Occasional checks relating to need for updating may suffice. Frequency of update checks may be based upon elapsed time, time since last query relating to a particular information owner, or other parameters.

If the permission criteria do not require updating (or if no need for updating is to be evaluated), method 100 proceeds according to NO response line 114 and the information use permission query is compared with the information use directions manifested in the permission criteria (established pursuant to block 102) to ascertain whether the permission criteria are satisfied, as indicated by a query block 116.

If the permission criteria are not satisfied for the specified information in the respective use circumstance, method 100 proceeds according to NO response line 1 18, the information use permission query is denied (manifested in a denying permitting indicator sent to the requesting information user) and method 100 returns via return lines 120, 122 to block 104 for receiving a next information use permission query. If the permission criteria are satisfied for the specified information in the respective use circumstance, method 100 proceeds according to YES response line 124, and a query is posed whether the requested information is available, as indicated by a query block 126.

The preferred embodiment of the method of the present invention contemplates employment in offering a service to information users so that an information user may inquire whether a particular use circumstance is permitted for specified information relating to a particular information owner. In such an embodiment, no inquiry is made regarding whether certain information is available, merely whether permission is accorded for the specified information in the respective use circumstance for which the inquiring information user seeks clearance.

The query represented by query clock 126 refers to employment of an alternate embodiment of the method of the present invention in situations where information is available and authorized for dissemination in certain predetermined circumstances. The query represent by query block 126 would be involved in the method of the present invention, for example, in a situation when an information use permission query is posed by an information user in a form that describes desired information in general terms without specifying any owner requirements, so that a class of information fits the description. Method 100 may respond to such a descriptive request by posing the query represented by query block 126 in anticipation of providing identifying information from stored permissions criteria information, subject to the permission criteria of the various subscribing information owners whose information is stored. As mentioned earlier, such a descriptive information request not designating particular information owners may be employed by an information user to facilitate creation of a mailing list. When a check whether specified information is available is performed pursuant to the query represented by query block 126, information may be searched and provided from a local database (e.g., permission criteria storage unit 52; FIG. 1) containing permission criteria and identifying information relating to information owners. If remote databases are accessible as well, the check whether specified information is available may include those remote databases as well.

If information asked after by the query represented by query block 126 is available, method 100 proceeds according to YES response line 128, permission to use the information and the requested information are provided, as indicated by a block 130, and method 100 returns via return lines 132, 122 to block 104 for receiving a next information use permission query.

If no information is available, or if the information use permission query does not request information but merely requests permission to use information (as is contemplated for the preferred embodiment of the invention), method 100 proceeds according to NO response line 134 and method 100 provides permission subject to criteria restrictions, as indicated by a block 134. Provision of permission subject to criteria restrictions preferably is manifested in providing a permitting indicator to the information user when the respective use circumstance conforms with the information use directions for the specified information. It is further contemplated that a denial notice is sent to the information user when the respective use circumstance does not conform with the information use directions for the specified information. Method 100 continues from block 136 via return line 122 to block 104 for receiving a next information use permission query.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. A system for administering permission for use of specified information in a respective use circumstance by at least one information user; said specified information being owned by at least one information owner; the system comprising:
(a) an information control unit; said information control unit comparing an information use permission request with predetermined information use directions for effecting said administering; said information use permission request identifying at least said specified information and said respective use circumstance; said information use directions including criteria prescribing permitted use of said specified information;
(b) a communication facility coupled with said information control unit for effecting communication with said information control unit to receive said information use permission request from said at least one information user; said information control unit communicating a permitting indicator to said at least one information user using said communication facility when said respective use circumstance conforms with said information use directions for said specified information; and
(c) an information storage unit coupled with at least one of said information control unit and said communication facility for storing said information use directions.

2. A system for administering permission for use of specified information in a respective use circumstance by at least one information user as recited in claim 1 wherein said information control unit receives said information use directions from said at least one information owner via said communication facility.

3. A system for administering permission for use of specified information in a respective use circumstance by at least one information user as recited in claim 1 wherein respective said information use directions are submitted by a respective submitting information owner of said at least one information owner; said respective information use directions being stored in said information storage unit associated with each respective submitting information owner.

4. A system for administering permission for use of specified information in a respective use circumstance by at least one information user as recited in claim 1 wherein said communication facility effects communication via at least one communication milieu of a plurality of communication milieux.

5. A system for administering permission for use of specified information in a respective use circumstance by at least one information user as recited in claim 2 wherein said communication facility effects communication via at least one communication milieu of a plurality of communication milieux.

6. A system for administering permission for use of specified information in a respective use circumstance by at least one information user as recited in claim 5 wherein said plurality of communication milieux includes Internet web site data entry.

7. A system for administering permission for use of specified information in a respective use circumstance by at least one information user as recited in claim 5 wherein said plurality of communication milieux includes telephone communication using voice over Internet protocol equipment.

8. A system for administering permission for use of specified information in a respective use circumstance by at least one information user as recited in claim 5 wherein said plurality of communication milieux includes telephone communication using a public switched telephone network.

9. A system for administering permission for use of specified information in a respective use circumstance by at least one information user as recited in claim 5 wherein said plurality of communication milieux includes e-mail communication via a network.

10. A method for administering permission for use of specified information in a respective use circumstance by at least one information user; said specified information being owned by at least one information owner; the method comprising the steps of:
(a) in no particular order:
(1) provide an information control unit;
(2) provide a communication facility coupled with said information control unit; and
(3) provide an information storage unit coupled with at least one of said information control unit and said communication facility;
(b) storing predetermined information use directions in said information storage unit;
(c) operating said communication facility to effect communication with said information control unit to receive an information use permission request from said at least one information user; said information use permission request identifying at least said specified information and said respective use circumstance;
(d) operating said information control unit to compare said information use permission request with said predetermined information use directions for effecting said administering; said information use directions including criteria prescribing permitted use of said specified information; and
(e) communicating a permitting indicator to said at least one information user using said communication facility when said respective use circumstance conforms with said information use directions for said specified information.

11. A method for administering permission for use of specified information in a respective use circumstance by at least one information user as recited in claim 10 wherein said information control unit receives said information use directions from said at least one information owner via said communication facility.

12. A method for administering permission for use of specified information in a respective use circumstance by at least one information user as recited in claim 10 wherein respective said information use directions are submitted by a respective submitting information owner of said at least one information owner; said respective information use directions being stored in said information storage unit associated with each respective submitting information owner.

13. A method for administering permission for use of specified information in a respective use circumstance by at least one information user as recited in claim 10 wherein said communication facility effects communication via at least one communication milieu of a plurality of communication milieux.

14. A method for administering permission for use of specified information in a respective use circumstance by at least one information user as recited in claim 11 wherein said communication facility effects communication via at least one communication milieu of a plurality of communication milieux.

15. A method for administering permission for use of specified information in a respective use circumstance by at least one information user; said specified information being owned by at least one information owner; the method comprising the steps of:
(a) establishing predetermined information use directions; said information use directions including use criteria prescribing permitted use of said specified information and identifying criteria identifying a respective said information owner owning said specified information;
(b) receiving an information use permission query from said at least one information user; said information use permission query identifying at least said specified information and said respective use circumstance;
(c) comparing said information use permission query with said information use directions;
(d) providing a permitting indicator to said at least one information user when said respective use circumstance conforms with said information use directions for said specified information.

16. A method for administering permission for use of specified information in a respective use circumstance by at least one information user as recited in claim 15 wherein said information permission use query identifies described information desired for use, and wherein said permitting indicator includes said described information.

17. A method for administering permission for use of specified information in a respective use circumstance by at least one information user as recited in claim 15 wherein information use permission query is received via at least one communication milieu of a plurality of communication milieux.

18. A method for administering permission for use of specified information in a respective use circumstance by at least one information user as recited in claim 16 wherein information use permission query is received via at least one communication milieu of a plurality of communication milieux.

19. A method for administering permission for use of specified information in a respective use circumstance by at least one information user as recited in claim 18 wherein said plurality of communication milieux includes Internet web site data entry and e-mail communication via a network.

20. A method for administering permission for use of specified information in a respective use circumstance by at least one information user as recited in claim 18 wherein said plurality of communication milieux includes telephonic communication; said telephonic communication including at least voice over Internet protocol communication, public switched telephone network communication, facsimile communication and wireless telephone communication.
